(19) United States
(12) Patent Application Publication
(10) Pub. No.: US 2007/0192729 A1
(43) Pub. Date: Aug. 16, 2007

(54) Document overview scrollbar

(75) Inventor: Rocky S. Downs, Seattle, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/351,626

(22) Filed: Feb. 10, 2006

(51) Int. Cl. G06F 3/00

(52) U.S. Cl. 715/786

(57) ABSTRACT

A document overview scrollbar renders a miniaturized replica of an entire document. The document overview scrollbar provides an efficient and expeditious tool for searching, navigating, and/or editing documents. A visual pattern in the document is easily identifiable in the replica in the scrollbar. This is particularly advantageous when the document is code being rendered by an integrated development environment (IDE), such as a code editor. Indentations, bookmarks, and/or breakpoints in the document are easily recognizable in the replica in the scrollbar, and vice versa.

### TECHNICAL FIELD

The technical field generally relates to displays and more specifically relates to scrollbar displays.

### BACKGROUND

Attempting to navigate through a document rendered on a display can be time consuming and cumbersome. For example, trying to find a specific paragraph or searching through thousands of lines of code can be frustrating. Current techniques include using a search tool that highlights, in the document be searched, the word or phrase entered into the tool. This still requires the user to search through the document to find the particular instance of the phrase being searched for. This can be frustrating if many occurrences of the phrase are highlighted. Also, if the phrase is misspelled or does not appear in the document exactly as entered into the search tool, no finds will be shown. Another technique is to utilize a scroll bar to navigate through a document. A user can cause the portion of the document being rendered on the display to scroll through the document via the scrollbar. This technique can be very slow, especially for large documents.

### SUMMARY

This Summary is provided to introduce a selection of concepts in a simplified form that are further described below in the Detailed Description Of The Illustrative Embodiments. This Summary is not intended to identify key features or essential features of the claimed subject matter, nor is it intended to be used to limit the scope of the claimed subject matter.

A document overview scrollbar renders a miniaturized replica of a document. Utilization of the document overview scrollbar provides an efficient and expeditious tool for searching, navigating, and/or editing documents. The document overview scrollbar creates an instant navigation route to a document to which it refers. Visual patterns in the document are easily identifiable in the replica in the scrollbar. The pattern makes it easy for a user to identify points of interest in the document. This is particularly advantageous when the document is code, such as being rendered by an integrated development environment (IDE), such as a code editor for example. Indentations, bookmarks, and/or breakpoints in the document are easily recognizable in the replica in the scrollbar, and vice versa. Selecting a portion of the miniaturized replica in the scrollbar results in the corresponding portion of the document being rendered on the display. For example, selecting a word, phrase, paragraph, or section of the replica, results in the rendering of the corresponding word, phrase, paragraph, or section of the document. Also, selecting a portion of the document results in the corresponding portion of the miniaturized replica in the scrollbar being identified.

### BRIEF DESCRIPTION OF THE DRAWINGS

The foregoing summary, as well as the following detailed description, is better understood when read in conjunction with the appended drawings. For the purpose of illustrating a document overview scrollbar, there is shown in the drawings exemplary constructions thereof; however, a document overview scrollbar is not limited to the specific methods and instrumentalities disclosed. In the drawings:

FIG. 1 is a diagram of an exemplary computing device for implementing a document overview scrollbar;

FIG. 2 is a depiction of display portions having exemplary text rendered therein;

FIG. 3 is an exemplary illustration of the document overview scrollbar being utilized to navigate, search, and edit a document;

FIG. 4 is an illustration depicting an exemplary relationship between a rendered document and the document overview scrollbar;

FIG. 5 is an exemplary depiction of marked search terms;

FIG. 6 is an exemplary illustration of the document overview scrollbar being utilized in conjunction with an IDE; and

FIG. 7 is a flow diagram of an exemplary process for rendering a document overview scrollbar.

### DETAILED DESCRIPTION OF ILLUSTRATIVE EMBODIMENTS

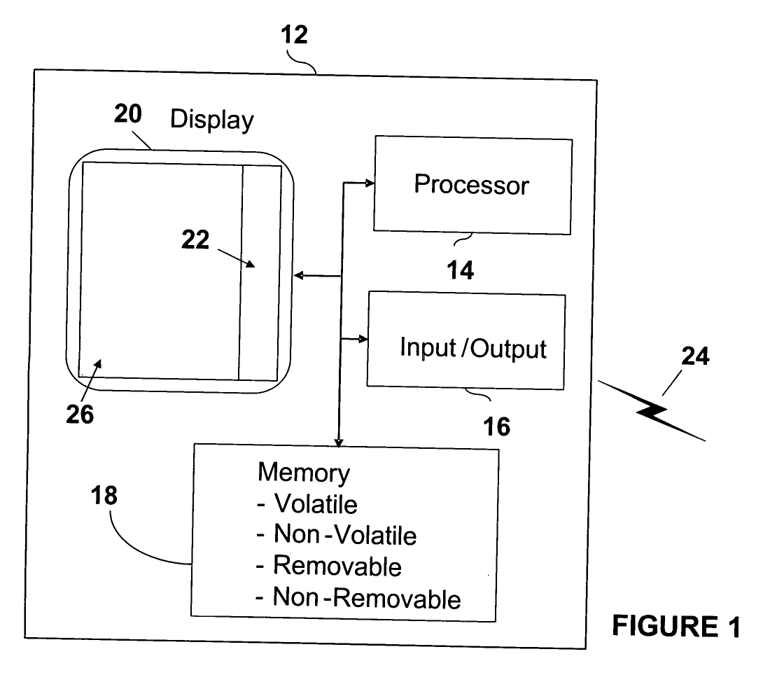

FIG. 1 is a diagram of an exemplary computing device 12 for implementing a document overview scrollbar 22. In a basic configuration, computing device 12 comprises a processing portion 14, memory portion 18, and display portion 20. Depending upon the exact configuration and type of computing device 12, memory portion 18 can be volatile (such as RAM), non-volatile (such as ROM, flash memory, etc.) or some combination thereof. Computing device 12 also can include additional features/functionality. For example, computing device 12 also can include additional storage (removable and/or non-removable) including, but not limited to, magnetic or optical disks or tape. Such additional storage is illustrated in FIG. 1 as part of memory 18. Computer storage media includes volatile and nonvolatile, removable and non-removable media implemented in any method or technology for storage of information such as computer readable instructions, data structures, program modules or other data. Memory 18, and any portion thereof, such as removable storage and non-removable storage, can be implemented utilizing computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 12. Any such computer storage media can be part of device 12.

Computing device 12 also can comprise an input/output portion 16 containing communications connection(s) that allow the device to communicate with other devices and/or networks via interface 24. Interface 24 can comprise a wireless interface, a hard-wired interface, or a combination thereof. Input/output portion 16 also can comprise and/or utilize communication media. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media. Input/output portion 16 also can comprise and/or utilize an input device(s) such as a keyboard, a mouse, a pen, a voice input device, a touch input device, or the like, for example. An output device(s) such as a display, speakers, printer, or the like, for example, also can be included.

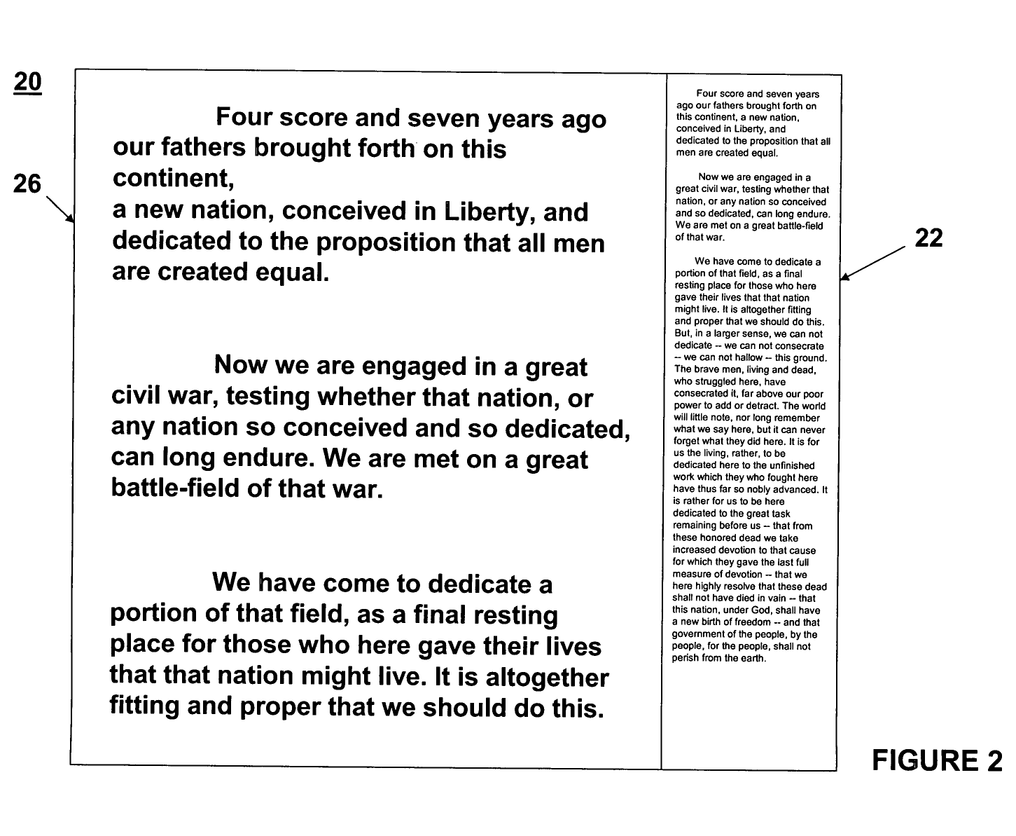

Display portion 20 comprises a portion 26 for rendering a document, or a portion thereof, and a scrollbar portion 22. FIG. 2 is a depiction of display portions 22 and 26 having exemplary text rendered therein. As depicted in FIG. 2, a portion of the document is rendered in display portion 26. A miniaturized replica of the entire document is rendered in scrollbar 22. The document is compressed to fit in scrollbar portion 22. This compression can be accomplished by any appropriate technique, such as by appropriately formatting the document for example (e.g., small font, reduced space between lines, reduced space between paragraphs, or the like).

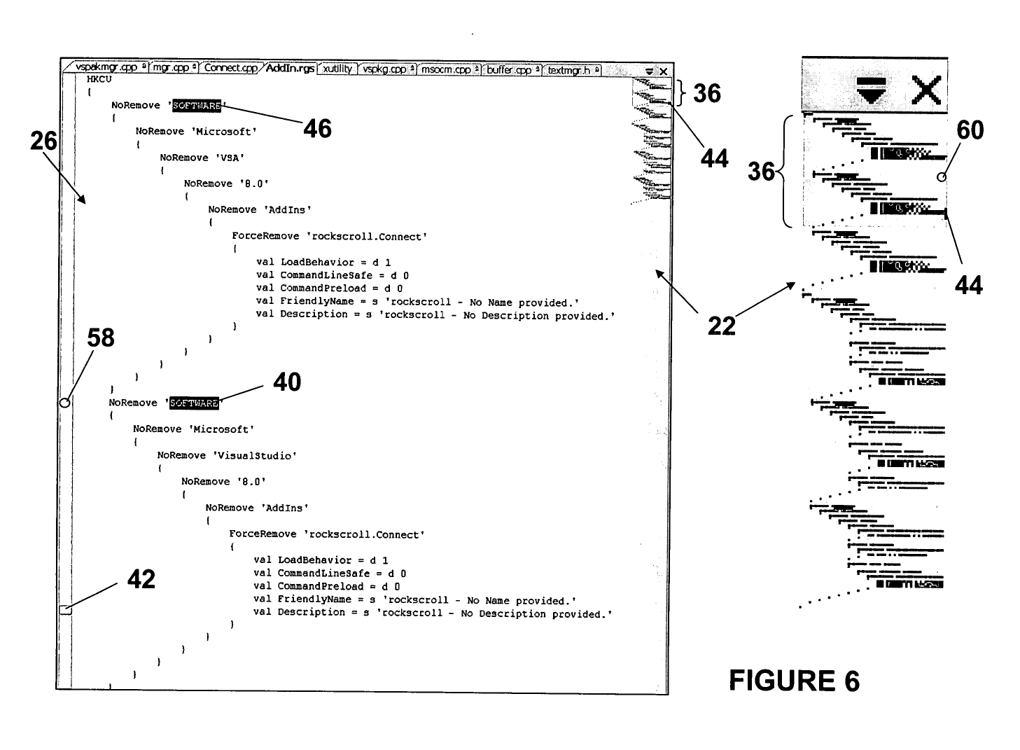

Viewing the rendering in the scrollbar 22 provides the viewer with a visual indication of a pattern of the document. This pattern may not be evident from viewing the document as rendered in display portion 26. As shown in FIG. 2, the document contains three paragraphs. Each paragraph is indented, and the last paragraph is longer than either of the first two paragraphs. Viewing a pattern of a document can be advantageous for indicating points of interest, such as indentations, if the document is, for example, code be edited/developed using a code editor (e.g., an IDE). An example of utilizing a document overview scrollbar with code is described in more detail below with reference to FIG. 6.

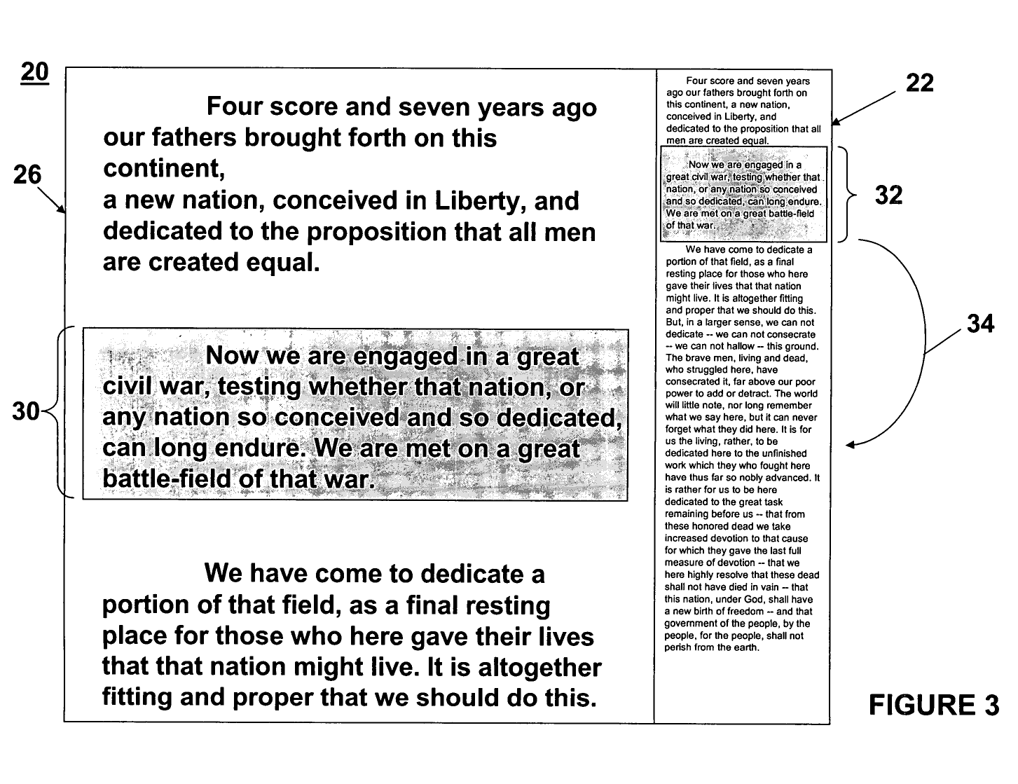

Utilization of the document overview scrollbar provides efficient and expeditious means for navigation, searching, and/or editing a document. FIG. 3 depicts an exemplary utilization of the document overview scrollbar 22 to navigate, search, and edit a document. Selection of a portion of a document, as depicted by shaded area 30, results in the corresponding portion of the replica being indicated, as depicted by shaded portion 32. Also, selection of a portion of the replica (shaded portion 32) results in an indication (shaded portion 30) of the corresponding portion in the document. Selection and/or indication can be accomplished by any appropriate means. For example, a portion of the document (or replica) can be highlighted, selected via a cursor, color coded, or the like.

In an exemplary embodiment, the document is editable via the scrollbar 22. For example, the portion 32 of the replica can be moved to another portion of the replica as indicated by arrow 34. This can be accomplished by any appropriate means, such as, for example, by selecting portion 32 and dragging the selected portion 32 to a desired location in the replica (e.g., as shown by arrow 34). This results in the corresponding portion of the document as rendered in display portion 26 being moved to the corresponding new location. Thus, the rendered version of the document in display portion 26 will reflect the edited document. The ability to view the entire document in document overview scrollbar 22 provides a more efficient (and easier to use) editing tool than scrolling through portions of the document rendered in display portion 26.

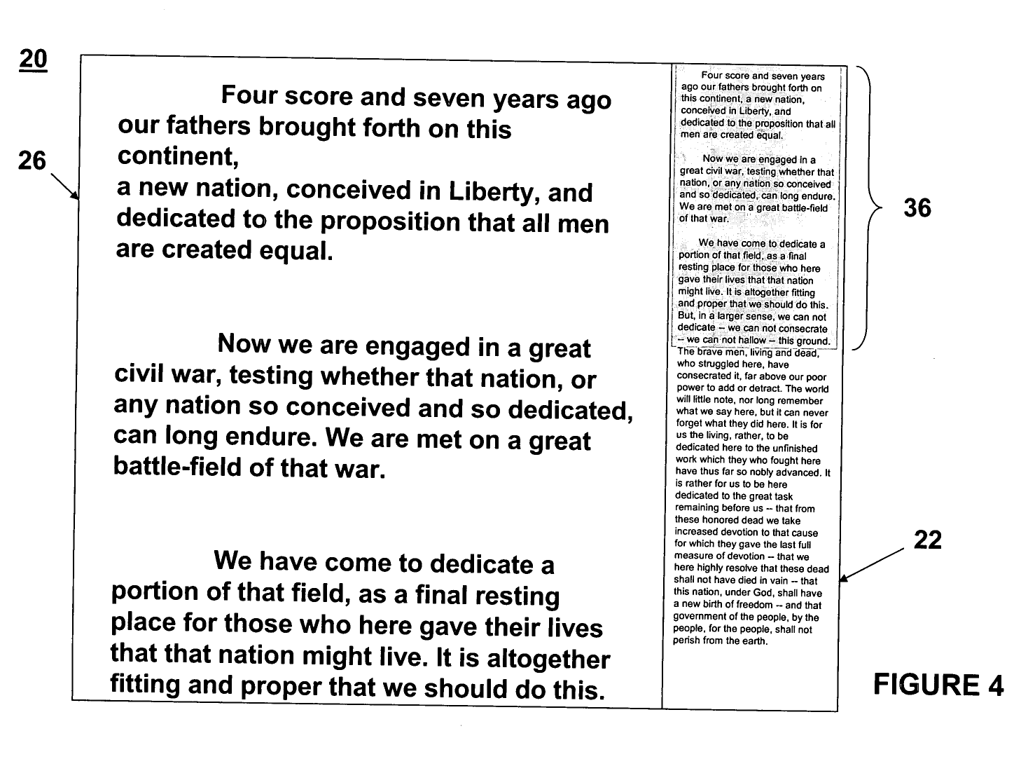

In an exemplary embodiment, as depicted in FIG. 4, the portion of the document being rendered on display portion 26, is indicated as such in the scrollbar 22, as indicated by shaded area (also referred to a thumb) 36. As the portion of the document rendered in display portion 26 is varied, the indicated portion (e.g., thumb 36) of the replica in scrollbar 22 is similarly varied. For example, if the font size of the document was reduced to render more of the document in display portion 26, the indicated portion of the replica in the scrollbar 22 would correspondingly increase. Indication can be accomplished by any appropriate means. For example, a portion of the replica can be highlighted, selected via a cursor, color coded, or the like.

In an exemplary embodiment, left-clicking thumb 36 in the scrollbar 22 provides instant navigation in the document in the display portion 26. For example, a left click can occur any where in the scroll bar 22 and the thumb 36 will center on the clicked point. And, the display portion 26 will similarly adjust its view of the document to coincide with the thumb 36.

A term or phrase in the replica in the scrollbar 22 can be selected resulting in the corresponding portion of the document being rendered in the display portion 26. Selection can be accomplished by any appropriate means, such as double clicking for example. For example, if the last word, “earth,” in the replica in scrollbar 22 was selected, the portion of the document rendered in display portion 26 would contain the last word “earth.”

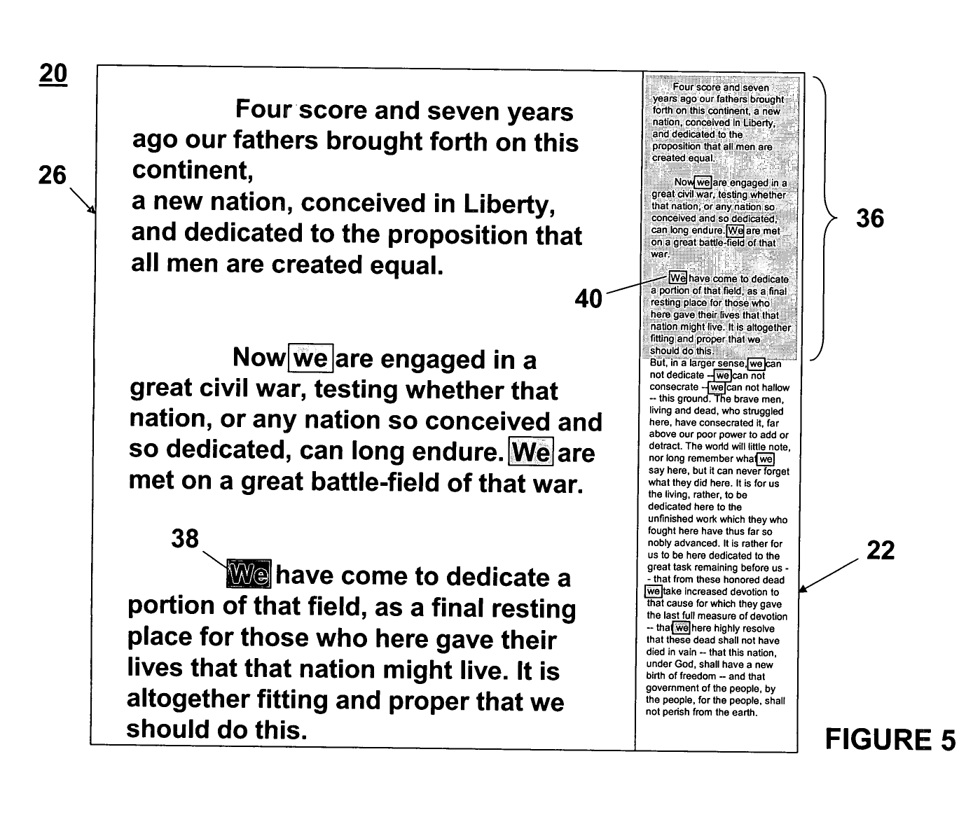

The document overview scrollbar can be utilized to search for terms in a document. FIG. 5 is an exemplary depiction of marked search terms. As depicted in FIG. 5, the term “we” (item 38) was selected for search. A term can be selected by any appropriate means, such as by double clicking, for example. Selecting the term “we” 38 results in all occurrences of the term “we” being indicated in the document and in the replica in the scrollbar 22. As can be seen in the replica in the scrollbar 22, the term “we” occurs in many instances throughout the document. Many of these occurrences are not evident by viewing the portion of the document rendered in display portion 26. The specific occurrence of the term “we” marked as item 38 is indicated differently than other occurrences of the term “we” in display portion 26 to indicate that this was the occurrence that was selected.

FIG. 6 is an exemplary illustration of document overview scrollbar 22 being utilized in conjunction with an IDE. Any appropriate IDE can be utilized, such as VISUAL STUDIO®, for example. An enlarged version of scrollbar 22 is depicted to the right of FIG. 6 to better illustrated features described below. As depicted in FIG. 6, scrollbar 22 is rendered as part of an IDE editor window. The document rendered in display portion 26 comprised a textual representation of code (referred to as code for the sake of simplicity). A miniaturized replica of the entire code is rendered in scrollbar 22. The code is compressed to fit in scrollbar portion 22. As described above, this compression can be accomplished by any appropriate technique, such as by appropriately formatting the document for example (e.g., small font, reduced space between lines, reduced space between paragraphs, or the like). As evident from viewing the replica in scrollbar 22, the code comprises a deeply nested pattern. Viewing this pattern of the entire code is advantageous for gaining an understanding of the functionality of the code, which is not available from viewing only a portion of the code rendered in display portion 26.

Selection of a portion of the code in display portion 26 results in the corresponding portion of the replica being indicated. Also, selection of a portion of the replica in scrollbar 22 results in an indication of the corresponding portion in the code rendered in display portion 26. Selection and/or indication can be accomplished by any appropriate means. For example, a portion of the document (or replica) can be highlighted, selected via a cursor, color coded, or the like.

As described above with reference to FIG. 3, the code is editable via the scrollbar 22. For example, a portion of the replica can be moved to another portion of the replica. This can be accomplished, for example, by selecting a portion in the replica and dragging the selected portion to a desired location in the replica. This results in the corresponding portion of the code being moved to the corresponding new location.

As depicted in FIG. 6, the portion of the code being rendered on display portion 26, is indicated as such in the scrollbar 22, by shaded area 36. As the portion of the code rendered in display portion 26 is varied, the indicated portion (e.g., display 36) of the replica in scrollbar 22 is similarly varied. For example, if the font size of the code was reduced to render more of the code in display portion 26, the indicated portion of the replica in the scrollbar 22 would correspondingly increase. Indication can be accomplished by any appropriate means. For example, a portion of the replica can be highlighted, selected via a cursor, color coded, or the like. A term or phrase in the replica in the scrollbar 22 can be selected resulting in the corresponding portion of the code being rendered in the display portion 26. Selection can be accomplished by any appropriate means, such as double clicking for example.

The document overview scrollbar 22 can be utilized to search for terms in the code. As depicted in FIG. 6, the term “SOFTWARE” (item 40) was selected for search. A term can be selected by any appropriate means, such as by double clicking, for example. Selecting the term “SOFTWARE” 40 results in all occurrences of the term “SOFTWARE” being indicated in the code and in the replica in the scrollbar 22. As can be seen in the replica in the scrollbar 22, the term “SOFTWARE” occurs in many instances throughout the document. Many of these occurrences are not evident by viewing the portion of the code rendered in display portion 26. The specific occurrence of the term “SOFTWARE” marked as item 40 is indicated differently than other occurrences of the term “SOFTWARE” in display portion 26 to indicate that this was the occurrence that was selected. For example, the word “SOFTWARE” 40 can be highlighted in blue. The blue color indicates that this occurrence of the term was selected. The word “SOFTWARE” 46 can be highlighted in red. The red color indicates that this occurrence of the term was not selected. It is to be understood that any appropriate means can be utilized to distinguish selected terms from non-selected terms, and that such means is not limited to color coding.

Indicator 44, depicted as a small dark blue square in the bottom right corner of area 36 is indicative of a bookmark set in display portion 26 (e.g., the editor window). Bookmark 44 corresponds to bookmark 42 illustrated in the left margin of display portion 26 (e.g., the editor window). The thumb of the scrollbar works like the thumb of the normal scrollbar. Left clicking in the scrollbar provides instant navigation in the editor window.

Indicator 60, depicted as a small dark blue circle on the right side of area 36 is indicative of a breakpoint set in display portion 26 (e.g., the editor window). Breakpoint 60 corresponds to breakpoint 58 illustrated in the left margin of display portion 26 (e.g., the editor window).

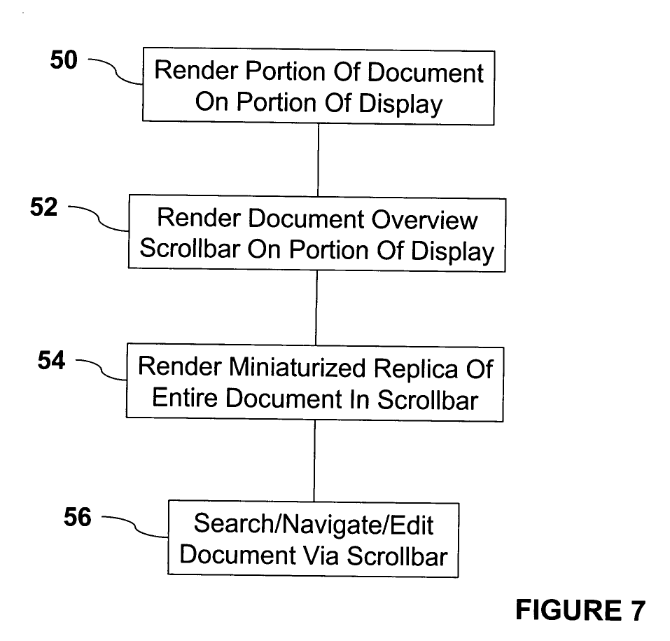

FIG. 7 is a flow diagram of an exemplary process for rendering a document overview scrollbar. A portion of the document is rendered at step 50. As described above, any appropriate document can be rendered, such as text and/or code, for example. The portion of the display on which the document is rendered can be any appropriate portion. For example, the document can be rendered to the left of the display (as depicted by display portion 26 above, to the right of the display, at the bottom of the display, at the top of the display, in the center of the display, around the perimeter of the display, in multiple contiguous or noncontiguous display portions, or a combination thereof).

The document overview scrollbar is rendered on a portion of the display at step 52. The portion of the display on which the scrollbar is rendered can be any appropriate portion. For example, the scrollbar can be rendered to the left of the display (as depicted by display portion 22 above, to the right of the display, at the bottom of the display, at the top of the display, in the center of the display, around the perimeter of the display, in multiple contiguous or noncontiguous display portions, or a combination thereof).

A miniaturized replica of the entire document is rendered within the scrollbar at step 54 and the document can be search, navigated, and/or edited via the scrollbar at step 56. Searching, navigating, and editing can be accomplished as described above.

The various techniques described herein can be implemented in connection with hardware or software or, where appropriate, with a combination of both. Thus, the methods and apparatuses for a document overview scrollbar or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for a document overview scrollbar. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. In any case, the language can be a compiled or interpreted language, and combined with hardware implementations.

The methods and apparatuses for implementing a document overview scrollbar also can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for implementing non-fact based authentication. When implemented on a general-purpose processor, the program code combines with the processor to provide a unique apparatus that operates to invoke the functionality of a document overview scrollbar. Additionally, any storage techniques used in connection a document overview scrollbar can invariably be a combination of hardware and software.

While implementation of a document overview scrollbar have been described in connection with the exemplary embodiments of the various figures, it is to be understood that other similar embodiments can be used or modifications and additions can be made to the described embodiments for performing the same functions of a document overview scrollbar without deviating therefrom. For example, the replica of the document rendered in the document overview scrollbar, need not necessarily be miniaturized. If the document is small enough, the replica can be the same or even larger than the original document. In an exemplary embodiment, the document overview scrollbar comprises a thumb, similar to a thumb of a standard scrollbar, for scrolling through the document. The replica of the document need not be an exact duplication of the document. In an exemplary embodiment, the document overview scrollbar can comprise a translation of the document. For example the replica can comprise an HTML version of the document, or the replica can contain the viewable version of an HTML document. In another example, the replica can comprise source code and the document can comprise object code, or the replica can comprise object code and the document can comprise source code. In yet another example, the replica can contain a foreign language translation of the document. All search, navigation, and editing means are as describe above. Therefore, implementing a document overview scrollbar as described herein should not be limited to any single embodiment, but rather should be construed in breadth and scope in accordance with the appended claims.

What is claimed:

1. A display scrollbar comprising a rendered, miniaturized replica of a document to which said scrollbar refers.

2. A scrollbar in accordance with claim 1, wherein a visual pattern of said replica is indicative of at least one point of interest of said document.

3. A scrollbar in accordance with claim 1, wherein said document is editable via said scrollbar.

4. A scrollbar in accordance with claim 1, wherein:
a selection of a location in said replica results in a rendering of a corresponding location of said document;
said corresponding location of said document is rendered on a display on which said scrollbar is rendered; and
a selection of a location in a rendered document results in a marking of a corresponding location in said replica.

5. A scrollbar in accordance with claim 1, wherein said scrollbar comprises a translation of said document.

6. A scrollbar in accordance with claim 1, wherein:
said scrollbar and at least a portion of said document are rendered by an integrated development environment;
a selection of at least one of a breakpoint and a bookmark in said replica results in a rendering of a corresponding at least one breakpoint and bookmark in said document; and
said corresponding at least one breakpoint and bookmark is rendered on a display on which said scrollbar is rendered.

7. A scrollbar in accordance with claim 1, wherein:
said scrollbar and at least a portion of said document are rendered by an integrated development environment;
a selection of at least one of a breakpoint and a bookmark in said at least a portion of said rendered document results in a rendering of a corresponding at least one breakpoint and bookmark in said replica; and
said corresponding at least one breakpoint and bookmark is rendered on a display on which said scrollbar is rendered.

8. A scrollbar in accordance with claim 1, wherein highlighting a portion of one of said document and said scrollbar results in highlighting of a corresponding portion of said scrollbar and said document, respectively.

9. A method, implemented at least in part on a computing device, for rendering a scrollbar on a display, said method comprising:
rendering, on said display, at least a portion of a document; and
rendering, on said display, said scrollbar, wherein:
said scrollbar comprises a miniaturized replica of a document to which said scrollbar refers.

10. A method in accordance with claim 9, wherein a visual pattern of said replica is indicative of at least one point of interest of said document.

11. A method in accordance with claim 9, further comprising selecting a location in said replica, wherein:
said act of selecting said location in said replica results in a rendering of a corresponding location in said document; and
selecting a location in a rendered document results in a marking of a corresponding location in said replica.

12. A method in accordance with claim 9, further comprising rendering, within said scrollbar, a translation of said document.

13. A method in accordance with claim 9, wherein:
said scrollbar and at least a portion of said document are rendered by an integrated development environment; and
a selection of at least one of a breakpoint and a bookmark in said replica results in a rendering of a corresponding at least one breakpoint and bookmark in said document.

14. A method in accordance with claim 9, wherein:
said scrollbar and at least a portion of said document are rendered by an integrated development environment; and
a selection of at least one of a breakpoint and a bookmark in said at least a portion of said rendered document results in a rendering of a corresponding at least one breakpoint and bookmark in said replica.

15. A method in accordance with claim 9, further comprising highlighting a portion of one of said document and said scrollbar, wherein:
said act of highlighting a portion of one of said document and said scrollbar results in highlighting of a corresponding portion of said scrollbar and said document, respectively.

16. A computer-readable medium having computer-executable stored thereon for performing the acts of:
rendering, on a display, at least a portion of a document; and
rendering, on said display, said scrollbar, wherein:
said scrollbar comprises a miniaturized replica of a document to which said scrollbar refers.

17. A computer-readable medium in accordance with claim 16, wherein a visual pattern of said replica is indicative of at least one point of interest of said document.

18. A computer-readable medium in accordance with claim 16, further comprising computer-executable instructions for selecting one of a location in said replica and a location in said document, wherein:
said act of selecting one of said location in said replica and said location in said document results in a rendering of a corresponding location in one of said document and said replica, respectively.

19. A computer-readable medium in accordance with claim 16, wherein:
said scrollbar and at least a portion of said document are rendered by an integrated development environment; and
a selection of at least one of a breakpoint and a bookmark in said replica results in a rendering of a corresponding at least one breakpoint and bookmark in said document.

20. A computer-readable medium in accordance with claim 16, wherein:
said document is editable via said scrollbar; and
said scrollbar comprises a translation of said document.
